(19) United States
(12) Patent Application Publication
(10) Pub. No.: US 2002/0073142 A1
(43) Pub. Date: Jun. 13, 2002

(54) Messaging

(76) Inventor: Thomas Moran, Kingston (IE)

Correspondence Address: Lee, Mann, Smith, McWilliams, Sweeney & Ohlson, P.O. Box 2786, Chicago, IL, 60690-2786, US

(21) Appl. No.: 09/734,975

(22) Filed: Dec. 11, 2000

(51) Int. Cl. G06F 15/16

(52) U.S. Cl. 709/203; 379/67.1

(57) ABSTRACT

The concept of voice mail or voice answering systems is well known and used by many people. Everyone is familiar with the tedious routine of repeating their name, number and time of call after the beep. With the service of voice mail or answering devices most people have to repeat this information several times a day. A user is able to pre-record messages stored at a messaging server, such as voice, text or video messages, or multimedia messages comprising a combination of these. The user is then able to send one of the pre-recorded messages to the mail box of a destination party by providing information about the directory number of the destination party mail box and, for example, pressing a particular function key on a telephone handset. It is also possible for the user to append additional information onto a pre-recorded message such that both the pre-recorded message and the appended information are sent to the destination party mail box.

### FIELD OF THE INVENTION

This invention relates to a messaging system and method. The invention is particularly related to, but in no way limited to a messaging system and method which are applicable to many different communications media. A particular application is telecommunications both from a traditional stand point and over the internet.

### BACKGROUND TO THE INVENTION

The concept of voice mail or voice answering systems is well known and used by many people. Everyone is familiar with the tedious routine of repeating their name, number and time of call after the beep. With the service of voice mail or answering devices most people have to repeat this information several times a day. This is both time consuming and can be annoying. In addition as many people are uncomfortable with using answering machines it is not uncommon for no message to be left at all.

### OBJECT TO THE INVENTION

An object of the present invention is to provide a messaging system which overcomes at least some of the problems of the prior art and which is easy to use.

### SUMMARY OF THE INVENTION

According to one aspect of the present invention there is provided a messaging system arranged to allow a user to send a pre-specified message to a destination party mail box, said messaging system comprising a communications network comprising:

a messaging server arranged to store one or more pre-specified messages;

an input to the communications network arranged to receive a user input; and

a destination party mail box; wherein when a specified user input is received at the input, one of the pre-specified messages is sent to the destination party mail box from the messaging server.

A corresponding method is provided of sending a pre-specified message to a destination party mail box in a communications network, said method comprising the steps of:

storing said pre-specified message at a messaging server in the communications network;

receiving an input from a user, said input indicating that the pre-specified message is to be sent to the destination party; and

sending the pre-specified message from the messaging server to the destination party mail box.

For example, the pre-specified message can be a standard message containing the originator's details and a request to be called back. The input can be provided by a terminal such as a mobile phone or a conventional telephone terminal. The pre-specified messages are pre-recorded by the user and stored, for example, at the user's mail box at the messaging server. Several different pre-specified messages can be recorded by the user for use in different situations. Advantageously, no call needs to be set up between the terminal and the destination party mail box. This enables an originator to call a first party for example and during the call to the first party, send an instant message to another party.

The ability to send a message without having to keep repeating your name, telephone number and other details will encourage more people to use voice mail systems. In addition people will save considerable amounts of time over a typical day where numbers of messages usually have to be left by replacing these messages with a single button press.

Preferably the messaging server is a multi-media messaging server. This provides the advantage that the user is able to pre-specify a standard message comprising video and voice information for example. This pre-specified message can then be sent to a destination party mail box, with or without additional appended information.

Preferably, the messaging server comprises a processor arranged to append information received from a user to one of the pre-specified messages. This provides the advantage that a user is able to personalise instant messages and add information to them to suit particular circumstances. The messaging server is preferably local to the terminal so that the appending process occurs locally. Thus when the instant message and appended portion is sent on to the destination party mail box (which may be located on another messaging server) it is received as a combined whole that may be displayed to a user as a single message. The information to be appended to the pre-specified message is provided by the user by means of a call set up between the terminal and the messaging server.

Preferably, the processor is arranged to append the information received from the user to a pre-specified message in order to create a combined message such that in use the messaging server is later able to separate the appended information from the combined message. For example, a person receiving an instant message that has an appended portion may wish to skip the instant message portion and only access the appended portion. This facility is possible because the messaging server is able to separate the appended information from the combined message. For example, the receiver of the instant message may operate a graphical user interface which indicates that a combined message is received. The user is then able to select only the appended portion of that message.

According to another aspect of the present invention there is provided a messaging server for sending a pre-specified message to a destination party mail box in a communications network, said messaging server comprising:

a store containing the pre-specified message;

an input arranged to receive information, said information indicating that the pre-specified message is to be sent to the destination party mail box;

a processor arranged to send the pre-specified message to the destination party mail box.

According to another aspect of the present invention there is provided a communications network comprising a destination party mail box and a messaging server for sending a pre-specified message to the destination party mail box, said messaging server comprising:

a store containing the pre-specified message;

an input arranged to receive information, said information indicating that the pre-specified message is to be sent to the destination party mail box; and

a processor arranged to send the pre-specified message to the destination party mail box.

According to another aspect of the present invention there is provided a computer program for controlling a messaging server for sending a pre-specified message to a destination party mail box in a communications network, said computer program being arranged to control the messaging server such that:

a store containing the pre-specified message is accessed;

information is received at an input, said information indicating that the pre-specified message is to be sent to the destination party;

the pre-specified message is sent to the destination party mail box by a processor.

According to another aspect of the present invention there is provided a communications signal arranged to be routed between a terminal and a messaging server, said communications signal comprising information and a control signal which indicates that the information is to be appended to a pre-specified message at the messaging server. This provides the advantage that the user is able to append information to the pre-specified message in a simple manner. This provides greater flexibility for the user whilst at the same time reducing the time required for the user to leave the combined message.

According to another aspect of the present invention there is provided a communications network node arranged to be connected between a terminal and a messaging server, said communications network node comprising a processor arranged to set up a call between the terminal and the messaging server and to route information from the terminal to the messaging server using this call, wherein the processor is further arranged to send a control signal with the routed information, said control signal indicating that the routed information is to be appended to a pre-specified message at the message server.

This provides the advantage that the message server is aware that the information is to be appended to a pre-specified message. For example, the communications network node may be a personal branch exchange (PBX). The control signal can be for example a signalling extension added to conventional control signals that are sent with the routed information.

### BRIEF DESCRIPTION OF THE DRAWINGS

Reference will now be made by way of example to the accompanying drawings, in which:

FIG. 1 is shows a voice only instant messaging system.

FIGS. 2, 3a and 3b show three different scenarios of using an instant messaging system.

FIG. 4 is an overview of another embodiment of a communications system comprising a messaging system using a distributed internet protocol, public branch exchange (IP PBX) architecture;

FIG. 5 is a more detailed view of the messaging system of FIG. 4.

FIG. 6 shows two messaging systems connected via a wide area network (WAN).

### DETAILED DESCRIPTION OF INVENTION

Embodiments of the present invention are described below by way of example only. These examples represent the best ways of putting the invention into practice that are currently known to the Applicant although they are not the only ways in which this could be achieved.

The term “destination party mail box” is used herein to refer to the mail box to which it is required to send an instant message. In none of the methods described herein is it essential to set up a call between a originator and such a destination party mail box although one can.

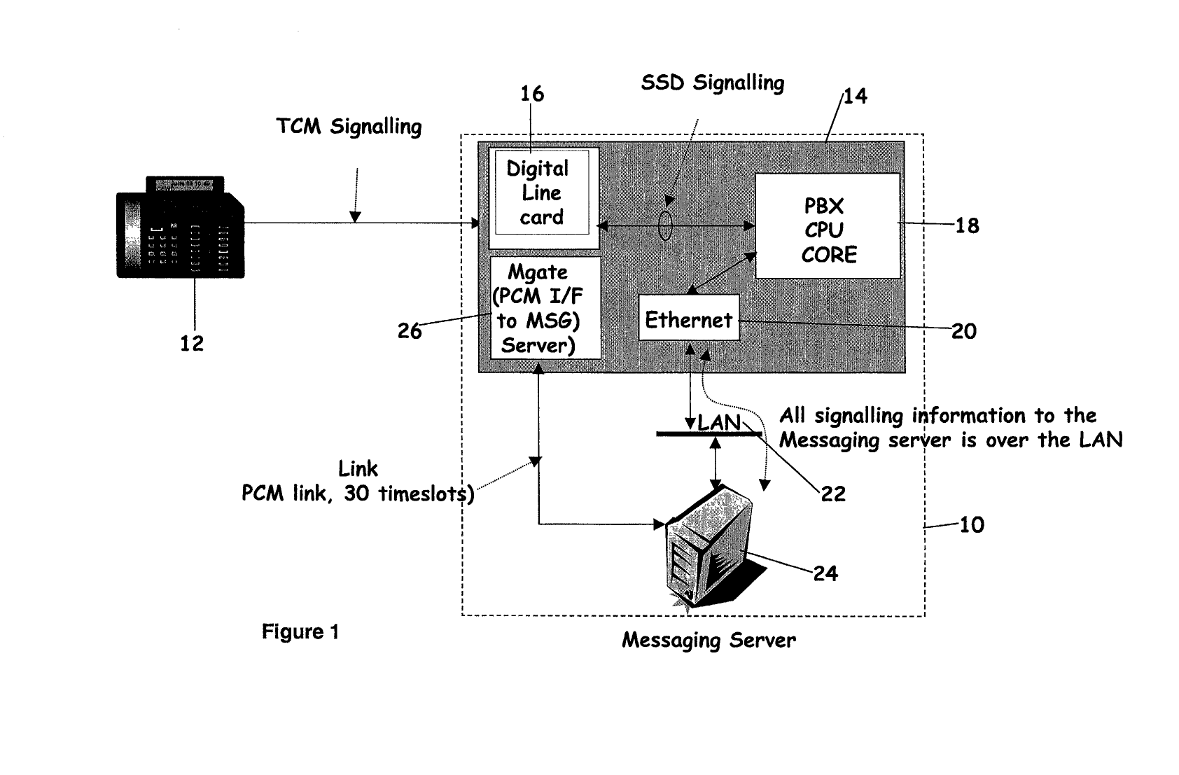

FIG. 1 shows a first embodiment of the invention comprising an instant messaging system 10 for voice messages. A telephone 12 (or any other suitable terminal) is connected to a communications network via a private branch exchange (PBX) 14 or any other suitable communications network node. Control signals are communicated between the telephone 12 and a digital line card 16 within the PBX using time compression multiplexing (TCM) or any other suitable type of signalling. The digital line card 16 is itself connected to a central processing unit (CPU) within the core of the PBX 18 and communication between the digital line card 16 and the PBX CPU core 18 takes place using scan and signal distribution (SSD) signalling or any other suitable type of signalling. The PBX CPU core 18 is connected via an Ethernet card 20 to a local area network (LAN) 22. A messaging server 24 is connected to the LAN and a messaging gateway (Mgate) 26 in the PBX 14. Any suitable type of messaging server may be used, such as a CallPilot (trade mark) messaging server as currently commercially available from Nortel Networks. The messaging gateway 26 comprises an Mgate card which interfaces to the external voice mail messaging server 24 over a PCM link such as a DS30X link with 30 time slots. The PBX CPU core 18 is connected to the Mgate card which is effectively treated by the PBX CPU core 18 as a plurality of telephones at which voice mail messages may be left. The signalling mechanism from the CPU core 18 to the MGATE card 26 is preferably also SSD although any suitable signalling mechanism may be used.

As indicated in FIG. 1 all signalling information to the messaging server 24 is sent from the PBX core 18 via the LAN. Calls, such as voice messages to be recorded in a voice mail system on the messaging server 24 are sent to the messaging server 24 via the messaging gateway 26. This is achieved using a pulse code modulation (PCM) link between the Mgate 26 and the messaging server 24.

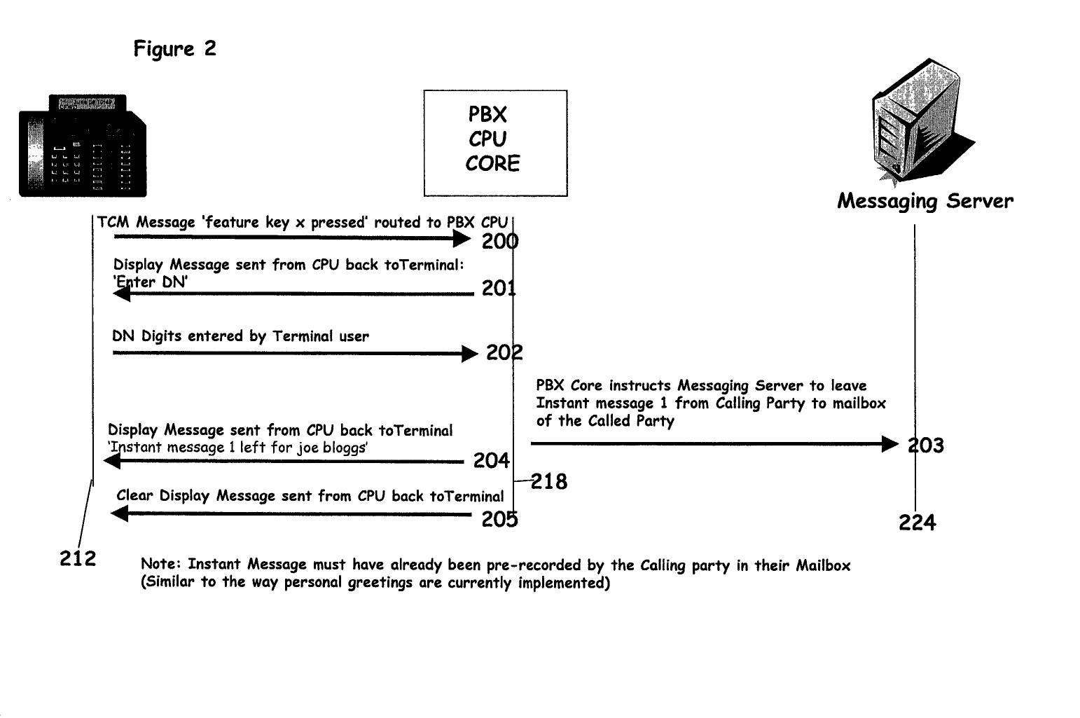

FIG. 2 is a high level message sequence chart showing a method of sending a pre-recorded message using the instant messaging system of FIG. 1. Items from the instant messaging system of FIG. 1 are represented by columns in FIG. 2. For example, the telephone 12 is represented by column 212, the PBX CPU core by column 218 and the messaging server by column 224. The direction of flow of messages between these entities is indicated by the direction of the arrows in FIG. 2 and the position of the arrows represents the chronological sequence in which the messages are sent. Because this message sequence chart is high level, each individual arrow may represent a plurality of messages sent between the two entities concerned as is known in the art.

Consider the situation in which a user requires to send a message to the voice mail box of a particular person. The user has previously recorded one or more suitable messages at the messaging server 224. The user first presses a feature key on the telephone 212 which indicates that the user requires to send one of the pre-recorded messages. A time compression multiplexed (TCM) control signal is sent from the telephone 212 to the PBX CPU core 218 as indicated by arrow 200. A display message is then sent back from the PBX CPU core 218 to the telephone 212 requesting the user to enter the telephone number of the voicemail box at which a message is to be left. This is indicated by arrow 201 of FIG. 2. The user next enters the directory number (DN) of the required voice mail box as indicated by arrow 202 and this DN is sent to the PBX CPU core 218. In turn the PBX CPU core 218 issues an instruction to the messaging server 224 which causes the messaging server 224 to record a copy of the pre-recorded message at the mail box of the destination party (see arrow 203). A display message 204 is then sent from the PBX CPU core 218 to the terminal 212 in order to indicate to the user which instant message has been sent and who the message has been left for. For example, the display message may read “instant message 1 has been left for joe bloggs”. Finally, a clear display message 205 is sent from the PBX CPU core 218 to the terminal 212 in order to clear the display at the terminal.

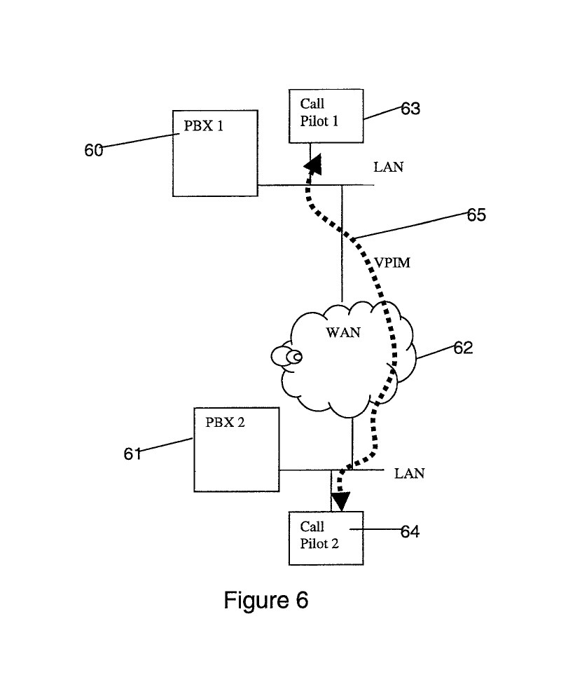

In the situation that the destination party mail box is on the same messaging server 224 as the mail box of the originating party, the messaging server is able carry out only internal processing in order to record the instant message at the destination party mail box. However, if the destination party mail box is stored on a different messaging server (such as a messaging server connected to another PBX) then the pre-recorded “instant” message is sent from the originating party messaging server to the destination party messaging server. This is illustrated in FIG. 6 which shows two PBXs 60, 61 connected via a wide area network 62. Two messaging servers are provided 63, 64 one connected to each PBX. Consider the case where a pre-recorded message is stored on one messaging server 63 and it is required to send this to a destination party mailbox on the second messaging server 64. In a preferred example the message is sent using the voice protocol for internet mail (VPIM) protocol as indicated by the dotted arrow 65 in FIG. 6. The VPIM specification, version 2 has been approved by the IETF as a proposed standard and has been published as request for comments (RFC) 2421. This specification is designed to allow the inter-exchange of voice and fax messages between voice messaging systems. Thus the pre-recorded message may be sent to a destination party fax machine.

It can be seen from FIG. 2 that it is not necessary to establish a call between the user's telephone 212 and the destination party. That is the destination party is able to receive or make voice calls to other parties during operation of the instant message method of FIG. 2. This provides the advantage that the destination party is not inconvenienced and is able to carry on using his or her telephone as usual.

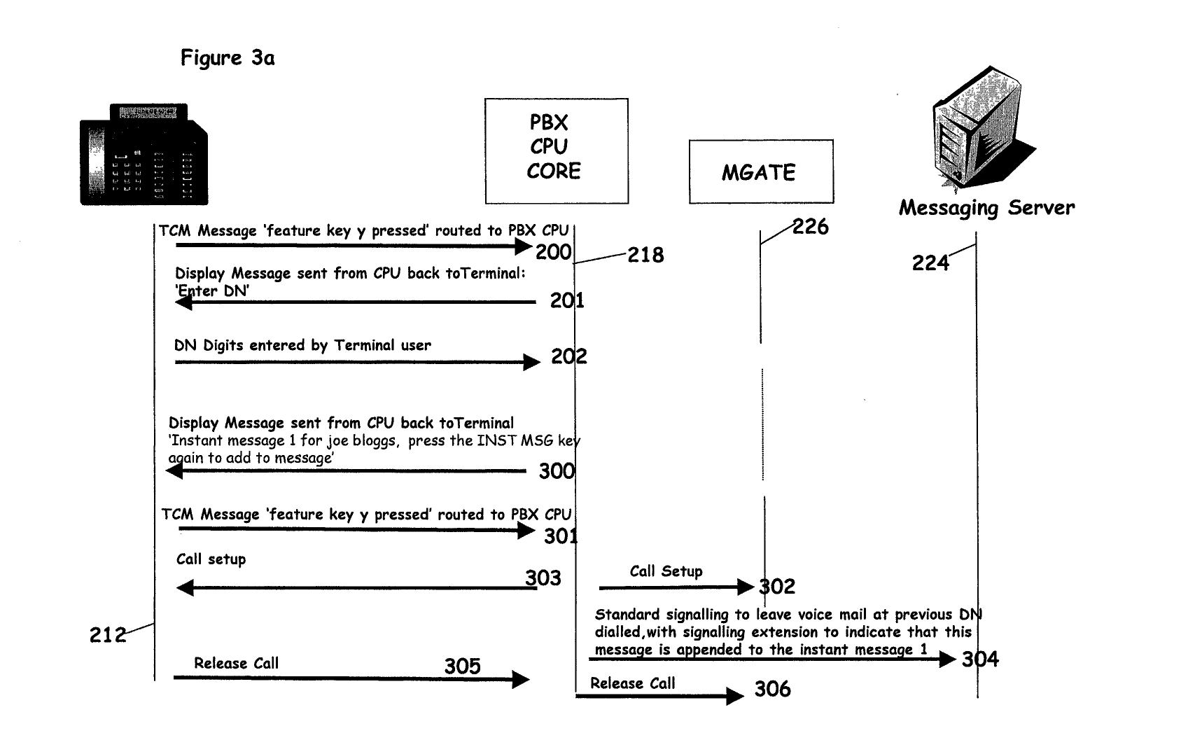

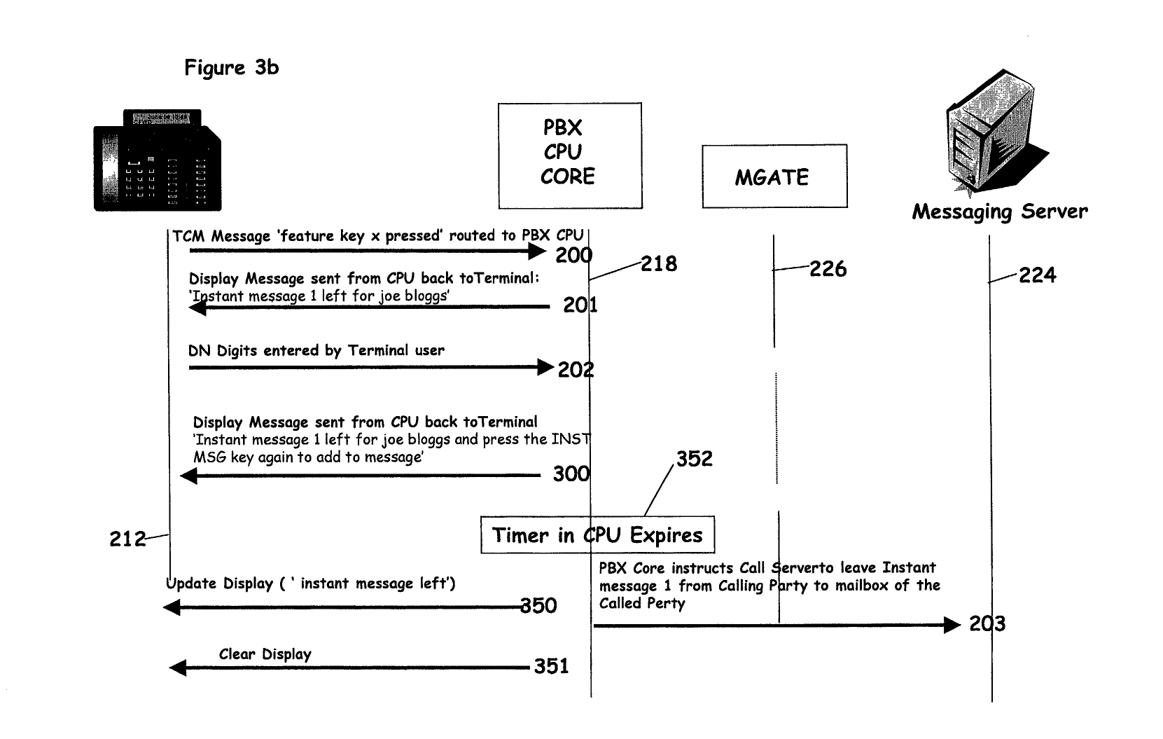

FIG. 3a is another high level message sequence chart showing a method of sending a pre-recorded message, and appending extra information to that pre-recorded message, using the instant messaging system of FIG. 1. As in FIG. 2, columns are used to represent entities in the instant messaging system of FIG. 1. The same reference numbers as in FIG. 2 are used for the same items. In addition, the mgate card 226 is represented by column 226. This also applied to FIG. 3b which again is a high level message sequence chart. FIG. 3b shows a method of sending a pre-recorded message where the ability to append extra information to that pre-recorded message is available but not used by the user.

The first three steps of the method are the same as those of FIG. 2. That is, the user first presses a feature key on the telephone 212 and this causes a TCM message to be sent to the PBX CPU core 218 indicating that the user requires to send an instant message (see arrow 200). The PBX CPU core 218 then sends a display message to the telephone 212 requesting the user to enter the directory number (DN) of the voice mail box at which the instant message is to be left (arrow 201). The user enters the directory number and this is communicated to the PBX CPU core 218 as indicated by arrow 202.

The PBX CPU core 218 then sends a display message back to the terminal 212 requesting the user to press the instant message feature key again if the user requires to add to the pre-recorded message (see arrow 300 in FIG. 3a. If the user does press the instant message feature key again, a TCM message indicating this is sent from the terminal 212 to the PBX CPU core 218 (see arrow 301 of FIG. 3a). A call is then set up between the terminal 212 and the MGATE card 226 and thus to the local messaging server as indicated by arrows 302 and 303 in FIG. 3a. In this example, the call is always set up between the terminal 212 and the local messaging server, even if the destination party mail box is located at a remote messaging server. The term “local messaging server” is used to refer to a messaging server at which the user's mail box is stored.

Once this call has been set up, the user then enters additional information to be appended to the instant message using the terminal 212. For example, by speaking the additional information. The local messaging server 224 receives this additional information and appends it to an instance of the instant message. The additional information is sent to the local messaging server using standard signalling but with a signalling extension being used, in order that the local messaging server 224 recognises the additional information as being for appending to an instant message.

The PBX CPU core 218 then issues an instructing message to the local messaging server (see arrow 304 in FIG. 3a). This instructs the local messaging server to leave the instant message with appended information at the mail box of the last dialled DN. This could be at the local messaging server 224 itself or at a remote messaging server. The call between the terminal 212 and the MGATE card 226 is then eventually released by the user as illustrated by arrows 305 and 306 in FIG. 3a.

As mentioned above, the instant message is preferably created at the messaging server that is local to the originator. In the case that the user appends onto the instant message, a call is set up to the originator's local messaging server and the full message is created at that messaging server. That is, the additional material is appended to the pre-recorded message at the originator's local messaging server to create a complete message. This complete message is then sent to the destination party mail box which may be located at a different messaging server. For example, this takes place using VPIM protocol as described with reference to FIG. 6 above.

In one embodiment, the local messaging server is arranged to append the additional material to the pre-recorded instant message in such a manner that it is later possible to separate the appended part from the combined message. At the same time however, the combined message, when played to a user appears to that user as a continuous combined message rather than two separate messages. For example, this is achieved by marking the combined message or using signalling information or in any other suitable manner. In this way, a user such as a destination party is later able to split a combined message into its constituent parts, for example, in order to skip the first pre-recorded part of the message that may already be known to that destination party.

FIG. 3b illustrates a method of sending an instant message in the case that the ability to append to an instant message is provided but not taken up by the user. The first four steps of the message sequence of FIG. 3b are identical to those of FIG. 3a. The user does not wish to append to the instant message and so does not press the instant message feature key. A timer in the PBX CPU core 218 eventually expires (see 352 in FIG. 3b) and the PBX CPU core 218 then proceeds to instruct the local messaging server 224 to send the instant message to the mail box of the destination party (see arrow 203 in FIG. 3b). An update display message is then sent from the PBX CPU core 218 to the terminal 212 in order to indicate to the user that the instant message has been left (see arrow 350 of FIG. 3b). After a predefined time interval, a clear display message is sent from the PBX CPU core 218 to the terminal 212 (see arrow 351 in FIG. 3b).

In the example shown in FIG. 3a, a call is set up between the user's telephone (or other suitable terminal) and the local messaging server 224. This differs from the methods of FIG. 2 and 3b in which no call is set up.

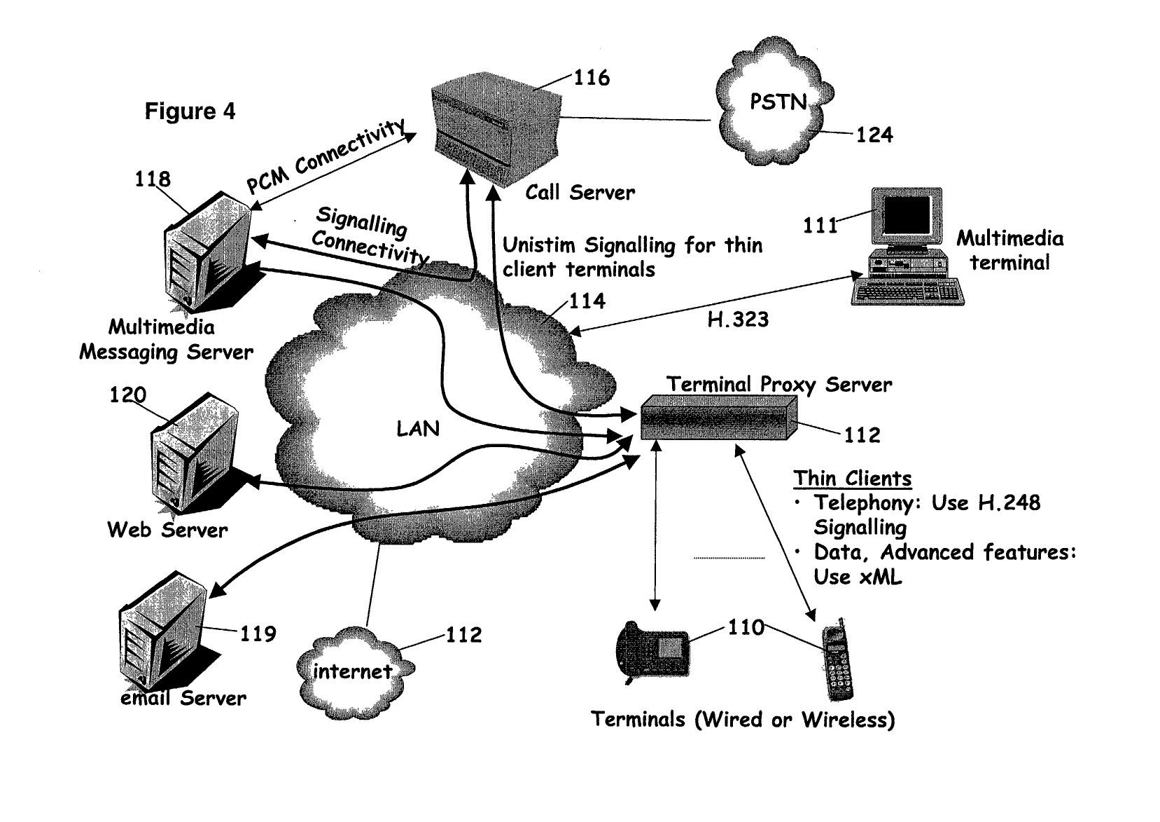

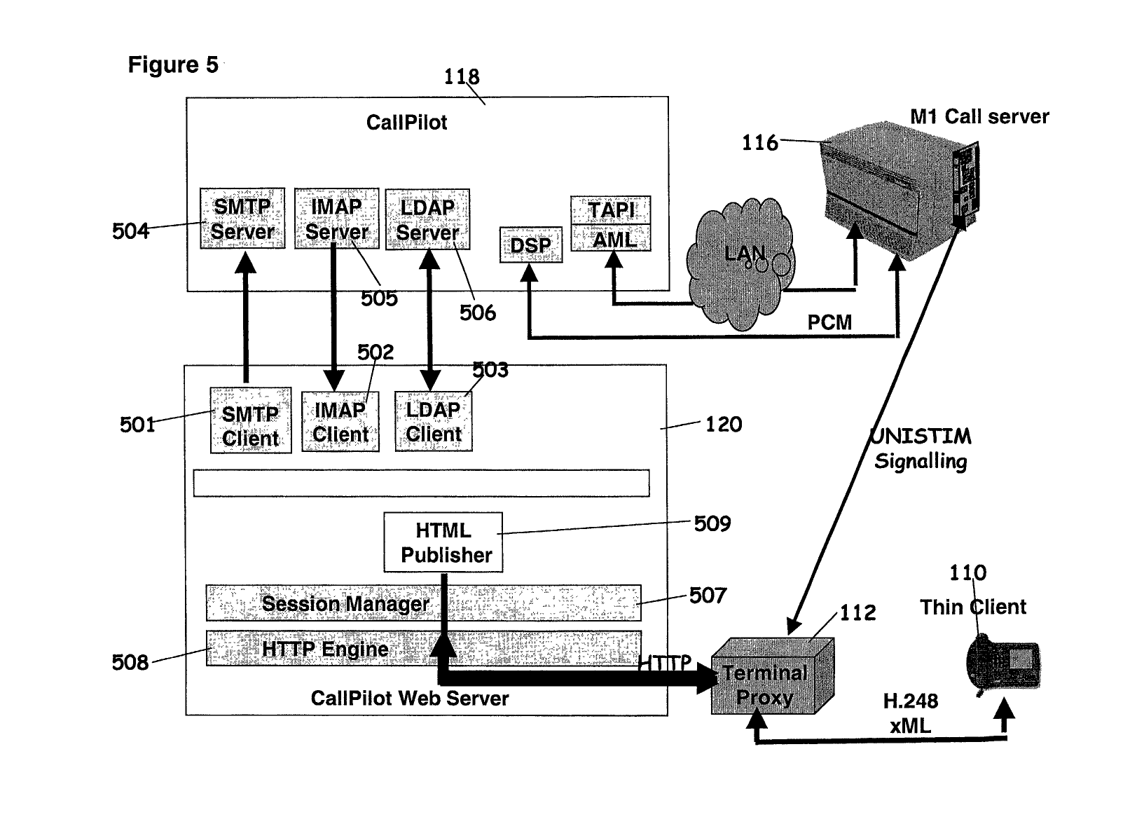

Referring to FIGS. 4 and 5 another embodiment of the instant messaging system is now described. In this embodiment, other types of messages besides voice messages can be sent and received. For example, video messages, fax messages, or HTML messages suitable for display using a web-browser. Other examples include, a standard email, and a standard short message to be left on a mobile phone such as a GSM phone. In this example, instant messages may be multimedia messages comprising both voice and video for example.

A terminal 110 is connected to a terminal proxy server 112. The terminal proxy server is connected to a local area network (LAN) 114. Various other servers may also be connected to the same LAN. Examples of such servers include a call server 116, a messaging server 118 (e.g. a CallPilot server), a web server 120, an email server 119 and the internet 122. The terminal 110 may be wired or wireless and can be for example, a PC phone, a conventional telephone or a mobile telephone. The call server (such as a private branch exchange, PBX) may be connected to a public switched telephone network (PSTN) 124. Also connected to the LAN is a multimedia terminal 111.

The system shown is best suited for a standard stimulus terminal. The terminals connected to the terminal proxy server 112 use a standard protocol such as H.248 (ITU defined) or media gateway control (MEGACO as defined by IETF). Preferably, these terminals have display capabilities and are arranged to display web-pages such as those provided using xML (extensible mark up language) or wireless mark-up language (WML). These terminals 110 are preferably arranged as so called “thin clients” wherein the bulk of any data processing occurs on the terminal proxy server 112 rather than at the terminals 110 themselves.

By using a terminal proxy server 112 as illustrated in FIG. 4 the user of terminal 110 has increased functionality because he or she is able to communicate with the web server 120, messaging server 118, email server 119 or call server 116. This contrasts with the situation of FIG. 1 in which the user's terminal is connected directly to a call server (PBX) and no direct connections to a web server or messaging server are provided. Also, a multimedia terminal 111 is provided via which a user is able to communicate with the web server 120, messaging server 118, email server 119, call server 116 or any other suitable server that is connected to the LAN.

The method of using the instant messaging system of FIG. 4 is similar to that shown in FIGS. 2 and 3 except that a terminal proxy server 112 is also involved and the message protocols used are suitable for multimedia.

As in the examples discussed with respect to FIGS. 2 and 3, the terminal 110 has a feature key or graphical interface which is pre-assigned for operating the instant messaging system (with or without the append facility). When the user selects this feature key or graphical interface, a message is sent from the terminal 110 to the terminal proxy server 112 and forwarded to the call server 116 using unistim protocol for example. This indicates to the call server 116 that the user requires the instant messaging capability. A display message is then sent from the call server 116 back to the terminal 110 via the terminal proxy server 112 in a similar the directory number (DN) of the destination party and the DN is sent to the multimedia messaging server 118 in order that an instant message is sent to the mail box of the destination party by the multimedia messaging server.

In the event that an append facility is provided, in a similar manner to that shown in FIGS. 3a and 3b, then a call is set up between the terminal 110 and the multimedia messaging server that is local to the terminal 110. This call involves setting up a direct path between the terminal and the local multimedia messaging server 118 using user datagram protocol (UDP) over internet protocol (IP).

In the case that the multimedia terminal 111 is used, methods similar to those described with reference to FIGS. 2, 3a and 3b again apply. In this case the protocol used in H.323 and the feature activation information is sent as a set of facility messages within the H.323 protocol.

FIG. 5 shows the instant messaging system of FIG. 4 in more detail although for a voice only situation, rather than a multimedia situation. As in FIG. 4 a terminal 110 is connected to a terminal proxy server 112, for example using H.248 for call signalling and xML for display capabilities. The terminal proxy server 112 is in turn connected to a call server such as an M1 call server 116 via a UNISTIM signalling link and also to a web server 120 via a hyper text transfer protocol (HTTP) link.

The web server 120 comprises an HTTP engine 508, a session manager 507, an HTML (hyper text mark up language) publisher 509 for publishing web pages and the following clients:

Simple Mail transfer protocol (SMTP) 501

Internet mail access protocol (IMAP) 502

Lightweight directory access protocol (LDAP) 503. LDAP is a protocol for accessing online directory servers that can run directly over TCP.

The HTTP engine 508 supports the hypertext transfer protocol which is also able to run directly over TCP.

The session manager 507 automatically creates new session objects whenever a new session starts. Session objects maintain state and user identity across multiple page requests over the normally stateless HTTP protocol. A session persists for a specified time period, across more than one connection or page request from the user.

The web server 120 is connected to the messaging server 118; that is each of the clients 501, 502, 503 in the web server is arranged to communicate with a corresponding server 504, 505, 506 within the messaging server 118.

The messaging server 118 is connected to the M1 call server 116 via a pulse code modulation (PCM) link and also via a local area network (LAN). The PCM link enables voice information that is to be appended to an instant message, or used to create an initial instant message, to be sent from the call server 116 to the messaging server 118. The LAN enables all signalling information to be passed between the call server and the messaging server. The LAN connects to an application module link within the messaging server 118 and the application module link connects to a telephone application programming interface (TAPI) in order to convert AML signalling format to a more standard TAPI format. (The signalling from the call server to the messaging server is preferably AML signalling although any other suitable type of signalling may be used.)

The PCM link to the messaging server 118 is connected to a digital signal processing module (DSP) within the messaging server.

A range of applications are within the scope of the invention. These include situations in which it is required to send pre-recorded messages to a terminal or mail box. For example, pre-recorded voice messages, video messages, text messages, HTML format messages or any other suitable type of message.

1. A messaging system arranged to allow a user to send a pre-specified message to a destination party mail box, said messaging system comprising a communications network comprising:
(i) a messaging server arranged to store one or more pre-specified messages;
(ii) an input to the communications network arranged to receive a user input; and
(iii) a destination party mail box; wherein when a specified user input is received at the input, one of the pre-specified messages is sent to the destination party mail box from the messaging server.

2. A messaging system as claimed in claim 1 wherein said input comprises a terminal connected to the communications network and comprising a user interface.

3. A messaging system as claimed in claim 2 wherein the terminal is connected to the messaging server via a communications network node such as a private branch exchange.

4. A messaging system as claimed in claim 1 wherein the messaging server comprises a processor arranged to append information received from a user to one of the pre-specified messages.

5. A messaging system as claimed in claim 1 wherein the messaging server comprises a processor arranged to append information received from a user to one of the pre-specified messages to create a combined message such that in use the messaging server is later able to separate the appended information from the combined message.

6. A messaging system as claimed in claim 5 wherein the processor is arranged to create the combined message such that in use, when the combined message is displayed to a user the appended information is displayed as part of the pre-specified message.

7. A messaging system as claimed in claim 1 wherein the messaging server is a multimedia messaging server.

8. A messaging system as claimed in claim 1 wherein the destination party mail box is located on a second messaging server.

9. A messaging system as claimed in claim 3 wherein the communications network node is arranged to route the additional information to the messaging server together with one or more control signals that are arranged to indicate that the additional information is to be appended to a pre-specified message.

10. A messaging system as claimed in claim 1 wherein the pre-specified messages are stored in a mail box on the messaging server, said mail box being associated with the user.

11. A method of sending a pre-specified message to a destination party mail box in a communications network, said method comprising the steps of:
(i) storing said pre-specified message at a messaging server in the communications network;
(ii) receiving an input from a user, said input indicating that the pre-specified message is to be sent to the destination party mail box; and
(iii) sending the pre-specified message from the messaging server to the destination party mail box.

12. A method as claimed in claim 11 wherein the input is received via a terminal.

13. A method as claimed in claim 12 which further comprises setting up a call between the terminal and the messaging server and receiving information from the user via this call, to be appended to the pre-specified message.

14. A method as claimed in claim 13 wherein the call is routed via a communications network node between the terminal and the messaging server and wherein that communications network node is arranged to send a control signal to the messaging server, indicating that the received information is to be appended to the pre-specified message.

15. A messaging server for sending a pre-specified message to a destination party mail box in a communications network, said messaging server comprising:
(i) a store containing the pre-specified message;
(ii) an input arranged to receive information, said information indicating that the pre-specified message is to be sent to the destination party mail box;
(iii) a processor arranged to send the pre-specified message to the destination party mail box.

16. A communications network comprising a destination party mail box and a messaging server for sending a pre-specified message to the destination party mail box, said messaging server comprising:
(i) a store containing the pre-specified message;
(ii) an input arranged to receive information, said information indicating that the pre-specified message is to be sent to the destination party mail box; and
(iii) a processor arranged to send the pre-specified message to the destination party mail box.

17. A computer program for controlling a messaging server for sending a pre-specified message to a destination party mail box in a communications network, said computer program being arranged to control the messaging server such that:
(i) a store containing the pre-specified message is accessed;
(ii) information is received at an input, said information indicating that the pre-specified message is to be sent to the destination party mail box;
(iii) the pre-specified message is sent to the destination party mail box by a processor.

18. A communications signal arranged to be routed between a terminal and a messaging server, said communications signal comprising information and a control signal which indicates that the information is to be appended to a pre-specified message at the messaging server.

19. A communications network node arranged to be connected between a terminal and a messaging server, said communications network node comprising a processor arranged to set up a call between the terminal and the messaging server and to route information from the terminal to the messaging server using this call, wherein the processor is further arranged to send a control signal with the routed information, said control signal indicating that the routed information is to be appended to a pre-specified message at the message server.
